(19) United States
(12) Patent Application Publication
(10) Pub. No.: US 2007/0084368 A1
(43) Pub. Date: Apr. 19, 2007

(54) Dynamic UV-exposure and thermal development of relief image printing elements

(76) Inventors: Ryan Vest, Cumming, GA (US); Richard J. Bigaouette, Chaska, MN (US); Gary T. Markhart, Carlsbad, CA (US)

Correspondence Address: John L. Cordani;Carmody & Torrance LLP, 50 Leavenworth Street, P.O. Box 1110, Waterbury, CT, 06721-1110, US

(21) Appl. No.: 11/249,864

(22) Filed: Oct. 13, 2005

(51) Int. Cl. B41N 1/00

(52) U.S. Cl. 101/395

(57) ABSTRACT

A method and a system for dynamic imaging, UV-exposure and thermal development of relief image printing elements, including printing plates and printing sleeves. The imaging step is accomplished using ink jet printing to create an in situ mask layer on a layer of photocurable material followed by exposing the photocurable layer to actinic radiation through the in situ mask. Thereafter, the printing element is developed in a thermal developing system to create the desired relief image in the surface. If desired, the improved system may also include means for post-exposing/detacking the printing element.

### FIELD OF THE INVENTION

The present invention is directed to a method and an apparatus for dynamic imaging, UV-exposure and thermal development of relief image printing elements, including printing plates and printing sleeves.

### BACKGROUND OF THE INVENTION

Flexography is a method of printing that is commonly used for high-volume runs. Flexography is employed for printing on a variety of substrates such as paper, paperboard stock, corrugated board, films, foils and laminates. Newspapers and grocery bags are prominent examples. Coarse surfaces and stretch films can be economically printed only by means of flexography. Flexographic printing plates are relief plates with image elements raised above open areas. Such plates offer a number of advantages to the printer, based chiefly on their durability and the ease with which they can be made.

Although photopolymer printing elements are typically used in “flat” sheet form, there are particular applications and advantages to using the printing element in a continuous cylindrical form, as a continuous in-the-round (CITR) photopolymer sleeve. CITR photopolymer sleeves add the benefits of digital imaging, accurate registration, fast mounting, and no plate lift to the flexographic printing process. CITR sleeves have applications in the flexographic printing of continuous designs such as in wallpaper, decoration and gift-wrapping paper, and other continuous designs such as tablecloths, etc. CITR sleeves also enable flexographic printing to be more competitive with gravure and offset on print quality.

A typical flexographic printing plate as delivered by its manufacturer, is a multilayered article made of, in order, a backing or support layer, one or more unexposed photocurable layers, a protective layer or slip film, and a cover sheet. A typical CITR photopolymer sleeve generally comprises a sleeve carrier (support layer) and at least one unexposed photocurable layer on top of the support layer.

The photopolymer layer allows for the creation of the desired image and provides a printing surface. The photopolymers used generally contain binders, monomers, photoinitiators, and other performance additives. Exemplary photopolymer compositions include those described in U.S. patent application Ser. No. 10/353,446 filed Jan. 29, 2003, the teachings of which are incorporated herein by reference in their entirety. Various photopolymers such as those based on polystyrene-isoprene-styrene, polystyrene-butadiene-styrene, polyurethanes and/or thiolenes as binders are also useful. Preferred binders include polystyrene-isoprene-styrene, and polystyrene-butadiene-styrene, especially block co-polymers of the foregoing.

The first step in manufacturing a flexographic relief image printing element generally comprises back exposing the printing element to actinic radiation through the back of the plate (transparent support layer) to cause the back of the plate to solidify and create a floor layer in the printing element that sets the depth of relief printing.

Next, the desired image is created in the photopolymerizable layer of the printing element. The desired image may be created in the photopolymer layer in an analog or “conventional” manner by means of a photographic mask placed on top of the photopolymer layer, which allows the layer to be selectively crosslinked and cured only in the areas that are not covered by the mask. In the alternative, the desired image can be created “digitally,” whereby an IR-ablatable layer, inkjet layer, or thermographic layer is used to create the mask on the photopolymer layer. Thereafter, the printing element is selectively exposed to actinic radiation through the mask to crosslink and cure the image.

Once the photopolymer layer of the printing element has been selectively exposed to actinic radiation, it may be developed by water washing, solvent washing, or thermally developed using heat. After development, the printing plate element may be post-exposed to further actinic radiation and is then ready for use.

It is highly desirable in the flexographic prepress printing industry to eliminate the need for chemical processing of printing elements in developing relief images, in order to go from plate to press more quickly. During thermal development, photopolymer printing plates are prepared using heat, and the differential melting temperature between cured and uncured photopolymer is used to develop the latent image. The uncured photopolymer (i.e., the portions of the photopolymer not contacted with actinic radiation) will melt or substantially soften while the cured photopolymer will remain solid and intact at the temperature chosen. The difference in melt temperature allows the uncured photopolymer to be selectively removed thereby creating an image.

The basic parameters of this process are known, as described in U.S. Pat. Nos. 6,773,859, 5,279,697, 5,175,072 and 3,264,103, in published U.S. patent publication Nos. U.S. 2003/0211423, and in WO 01/88615, WO 01/18604, and EP 1239329, the teachings of each of which are incorporated herein by reference in their entirety. These processes allow for the elimination of development solvents and the lengthy plate drying times needed to remove the solvent. The speed and efficiency of the process allow for use of the process in the manufacture of flexographic plates for printing newspapers and other publications where quick turnaround times and high productivity are important.

Once the printing element has been heated to soften the uncured photopolymer, the uncured photopolymer is removed. In some instances, the heated printing element is contacted with a material that absorbs or otherwise removes the softened or melted uncured photopolymer. This removal process is generally referred to as “blotting,” and is typically accomplished using a screen mesh or an absorbent fabric. In most instances, blotting is accomplished using rollers to bring the material and the heated printing element into contact. In the alternative, the material may be removed by processing the heated printing element using a hot air or liquid stream under superatmospheric pressure, as described in WO 01/90818, or by using a doctor blade to remove the uncured photopolymer.

Thereafter, the printing element may optionally be subjected to one or more post-treatment steps. For example, the printing element may be uniformly post-exposed to actinic radiation. A detackification step can also be performed on the surface, by means of a bromide solution or exposure to UV-C light as is well known in the art.

Imaging, exposing, developing and post exposure/detack steps have traditionally been carried out in separate devices. This requires additional time to transfer the printing element between the separate devices and can affect the quality of the finished plate as a result of handling the printing element. Thus, it would be desirable to accomplish the imaging, exposing, developing and post exposure/detack steps in the same system in order to improve both the quality and the accuracy of the final product.

U.S. Pat. No. 6,180,325 to Gelbart, the subject matter of which is herein incorporated by reference in its entirety suggests a method of applying a patterned coating to a printing element to form a mask and subsequently exposing the printing element to actinic radiation without dismounting it from the apparatus where the coating is applied. Gelbart also discloses that the imaging step may be accomplished using ink jet printing. However, there is no suggestion in Gelbart that the development step can be tied into the same system.

Thus, there remains a need in the art for an improved system that can accomplish the steps of imaging a printing element, exposing the printing element, and developing and post exposing/detacking the printing element in the same system in order reduce handling of the printing element, to make one machine do the work of multiple machines and provide for even and consistent imaging, exposure, development, and post exposure/detack of printing elements.

It is also desirable to have a system that is couplable to an inline processor, so that as the printing element travels along a chain or roller mechanism, it can be subsequently fed into the inline processor.

### SUMMARY OF THE INVENTION

It is an object of the present invention to provide an improved system for creating a relief image printing element that can accomplish multiple steps in the same system.

It is another object of the invention to provide an improved system that can accomplish imaging, exposing and development steps.

It is another object of the present invention to provide a system that is couplable to an inline processor.

To that end, the present invention is directed to a system for creating a relief image printing element comprising:

means for creating a digitally-imaged mask layer on the at least one photopolymerizable layer of the printing element;

means for exposing the at least one photopolymerizable layer to actinic radiation through the digitally imaged mask layer to selectively crosslink and cure the at least one photopolymerizable layer; and

means for thermally developing the printing element to soften and remove non-crosslinked photopolymer and reveal the relief image.

The roll(s) preferably have a blotting material positioned around at least the portion of the roll(s) in contact with the imaged surface of the relief image printing element. In an alternate embodiment, a doctor blade can be positioned adjacent to the roll(s) to remove non-crosslinked photopolymer from the roll(s) after it has been removed from the imaged surface of the relief image printing element.

The invention also comprises a method of imaging, exposing and developing a printing element to create a relief image thereon, the method comprising the steps of:

a) supporting a printing element comprising at least one photopolymerizable layer on a support layer;

b) creating a digitally-imaged mask layer on the at least one photopolymerizable layer;

c) exposing the at least one photopolymerizable layer to actinic radiation through the digitally-imaged mask layer to crosslink and cure selected portions of the at least one photopolymerizable layer;

d) melting or softening non-crosslinked photopolymer on the imaged and exposed surface; and

e) causing contact between the imaged and exposed surface and at least one roll to remove non-crosslinked photopolymer from the imaged and exposed surface of the relief image printing element.

### BRIEF DESCRIPTION OF THE DRAWINGS

FIG. 1 depicts one embodiment of the improved system of the instant invention, including imaging, exposing, and thermal development steps.

FIG. 2 depicts a different embodiment of the invention, in which the system also includes a post-exposure/detack device.

FIG. 3 depicts a view of the thermal development device of the invention.

FIG. 4 depicts another embodiment of the improved system of the invention in which a substantially planar printing element is supported on a substantially planar support.

Identical reference numerals in the figures are intended to indicate like features, although not every feature in every figure may be called out with a reference numeral.

### DETAILED DESCRIPTION OF THE PREFERRED EMBODIMENTS

The present invention relates to an improved system for imaging, exposing and developing a relief image printing element and a method of using the system of the invention to manufacture a relief image printing element.

The combined system for imaging, exposing and developing a relief image printing element, wherein the relief image printing element comprises at least one photopolymerizable layer on a support, typically comprises:

means for creating a digitally-imaged mask layer on the at least one photopolymerizable layer of the printing element;

means for exposing the at least one photopolymerizable layer to actinic radiation through the digitally imaged mask layer to selectively crosslink and cure the at least one photopolymerizable layer; and

means for thermally developing the printing element to soften and remove non-crosslinked photopolymer and reveal the relief image.

Prior to processing the printing elements in the combined system of the invention, the printing element may be back exposed through the support layer to create a floor in the photopolymerizable layer and establish the depth of printing relief. Thereafter, the printing element is processed in the combined system of the invention.

The printing element of the invention may also have a removable coversheet for protecting the printing element from damage. Thus, the system may further comprise means for removing the removable coversheet prior to imaging the printing blank.

The combined imaging, exposing and developing system of the invention may be configured in a variety of ways, depending in part on whether it is desired to process a substantially planar printing element or a cylindrical printing element. However, what is critical is the ability to process the printing element through imaging, exposing, developing, and optional post-exposure/detacking steps in the same system without having to handle the printing element between the various steps. Thus, the improved system of the invention allows for more accurate and efficient processing of the printing element than separate systems of the prior art.

Various setups of the combined imaging, exposing and developing system of the invention are set forth below. However, the invention is not limited to the setups described below, and the improved system of the invention is open to any setup in which it is possible to combine imaging, exposing and developing steps in a combined system for manufacturing flexographic relief image printing elements.

The means for imaging the surface of the photopolymerizable printing blank comprises a means for creating a digitally imageable layer, selected from the group consisting of inkjet print heads, IR lasers, and thermal printing heads and the digitally imageable layer is selected from the group consisting of inkjet layers, IR-ablatable layers, and thermographic layers respectively.

Plate materials may be selected from the group consisting of capped and uncapped sheet photopolymers as well as waterwash polymers.

IR-ablatable layers or masks are opaque to the wavelength of actinic light and usually comprise a film-forming thermally decomposable binder and at least one IR absorber, for example carbon black. Carbon black also ensures that the layer is opaque. Suitable binders are both binders such as polyamides or nitrocellulose, which are soluble in an organic medium, and binders such as polyvinyl alcohol or polyvinyl alcohol/polyethylene glycol graft copolymers, which are soluble in an aqueous medium. In the IR-ablative layer, it is possible to write into a mask by means of an IR laser, i.e. the layer is decomposed and removed in the areas where the laser beam is incident on it. Imagewise exposure to actinic light can be effected through the resulting mask. Examples of the imaging of flexographic printing elements using IR-ablatable masks are disclosed, for example in U.S. Pat. No. 5,925,500 to Yang et al. and U.S. Pat. No. 6,238,837 to Fan, the subject matter of each of which is herein incorporated by reference in its entirety.

The inkjet fluid may applied to the surface of the at least one photopolymerizable layer in one of several ways. In one embodiment, a pre-coat layer of material (inkjet receiving layer) is applied to provide a compatibility layer for the ink, as described for example in U.S. Pat. No. 6,358,668 to Leenders et al., the subject matter of which is herein incorporated by reference in its entirety. In another embodiment, the ink can be applied directly to the surface of the printing element, especially if compatibility (migration) issues are not observed.

Thermographic layers are transparent layers which contain substances which become black under the influence of heat. Such layers comprise, for example, a binder and an inorganic or organic silver salt and can be provided with an image by means of a printer having a thermal printing head, as described for example in U.S. Pat. No. 6,383,692 to Leenders et al., the subject matter of which is herein incorporated by reference in its entirety.

As seen in the Figures, in a preferred embodiment of the invention, the means for imaging the surface is at least one inkjet print head 16, and the relief image is formed via an additive process, in which an in situ negative is created by jetting the jetting fluid (ink jet ink) onto a surface of the printing element. Droplets of the jetting fluid are ejected from an inkjet recording head and directed to the surface to form an image thereon. Virtually any print head known in the art can be employed, so long as it comprises at least one nozzle which ejects ink droplets in response to control signals. The jetting fluid remains on top of the photopolymerizable layer and prevents the material beneath from being exposed to the radiation and thus those areas covered by the jetting fluid do not polymerize. The areas not covered by the jetting fluid are exposed to actinic radiation and polymerize and thus crosslink and cure.

An ink according to present invention is any liquid or solid moiety that is both substantially opaque to actinic radiation in at least one wavelength region effective to cure the above-described photopolymerizable elements and substantially resistant to polymerization upon exposure to actinic radiation in that wavelength region. Substantially opaque inks are those that can absorb at least about 85% of any incident actinic radiation, more preferably about 95%, and even more preferably 99.9% of such radiation. The jetting fluids (inks) can be water-based, phase change or solvent-based inks.

Phase change inks (also known as solid inks or hot melt inks) exist in a solid form at room temperature, but in a liquid phase at the elevated operating temperature of an ink jet printing device. At the jet operating temperature, droplets of liquid ink contact the surface of the photopolymerizable printing element and then quickly solidify to form a predetermined pattern of solidified ink drops. This resolidification process (or phase change) is practically instantaneous and a dry image is made immediately available to a user. Examples of phase change ink compositions are described in U.S. Pat. No. 6,444,018 to King et al., the subject matter of which is herein incorporated by reference in its entirety. Water-based inks typically comprise dyes or pigments, water, moistening agents such as glycols, detergents, thickeners, polymeric binders, and preservatives, as described in U.S. Pat. No. 6,358,668 to Leenders et al., the subject matter of which is herein incorporated by reference in its entirety.

Following close behind the at least one ink jet print head (or other imaging means) 16, is an exposure unit 18 comprising at least one source of actinic radiation that is capable of selectively crosslinking and curing the printing blank 14 through the in situ negative created in the imaging step. The at least one source of actinic radiation 18 typically comprise one or more UV light sources that are capable of selectively exposing and curing the imaged surface 12 of the relief image printing element 14, however any conventional sources of actinic radiation can be used for this exposure step. Examples of suitable visible or UV sources include carbon arcs, mercury-vapor arcs, fluorescent lamps, electron flash units, electron beam units and photographic flood lamps.

If desired, the source of actinic radiation may be collimated. Also, if desired, the light source may include a filter to prevent undue heating of the printing element and to allow the light source to be used in more than one capacity. During the main exposure of the photopolymerizable printing element, the light source is filtered so that the UV lights have a wavelength in the desired range (e.g., 365-400 nm) and the filter is adjusted to remove light that falls outside of this range. After development, if a detackification step is used, the same light source may be used, by filtering the light source to again have a wavelength in the desired range (e.g., less than 267 nm). Thus, the filter allows the light source to be used for multiple steps in the process. In another embodiment, the light sources may be collimated.

If an inkjet print head is used for the imaging step, the time between jetting and curing in critical because drops tend to spread after they are deposited on the surface. In order to quickly immobilize the jetted drops, it is preferable to mount the actinic radiation source close to the ink jet recording head so that as the drops are jetted, they are immediately immobilized.

Thereafter, the at least one photopolymerizable layer 12 of the printing element 14 is thermally developed to remove uncured (i.e., non-crosslinked) portions of the photopolymer, without disturbing the cured portions of the photopolymerizable layer, to produce the relief image.

In a preferred embodiment, the thermal developer comprises a blotting material 22 wrapped around at least a portion of at least one heatable roll 20. Thus, when the at least one heatable roll 20 is heated and is contacted with the imaged surface 12 of the relief image printing element 14, non-crosslinked polymer on the imaged surface 12 of the relief image printing element 14 is melted or softened by the heated roll 20 and is removed by the blotting material 22. Alternately, an external heating source 40 melts or softens the non-crosslinked polymer and the blotting material 22 positioned on at least a portion of the at least one roll 20 removes the melted or softened polymer.

The external heating source 40 may be an infrared heater or hot air heater, although other heating sources could also be used in the practice of the invention and would be known to those skilled in the art. In a preferred embodiment, the heating source 40 is an infrared heater.

The blotting material preferably comprises paper or woven or non-woven fabrics. Blotting materials that are usable include screen mesh and absorbent fabrics, including polymer-based and non-polymer-based fabrics. In a further refinement of the invention, in situations where it is desirable to provide additional security to the printing process and prevent unwanted copying of the printing plate (such as in the printing of banknotes or bills) a colored blotting material may be used to prevent an individual from using the used blotting material to make unwanted copies of the printing element. The colored blotting material may be approximately the same color as the printing element, so that the removed material would be virtually invisible on the surface of the blotting material or may alternatively be dark colored.

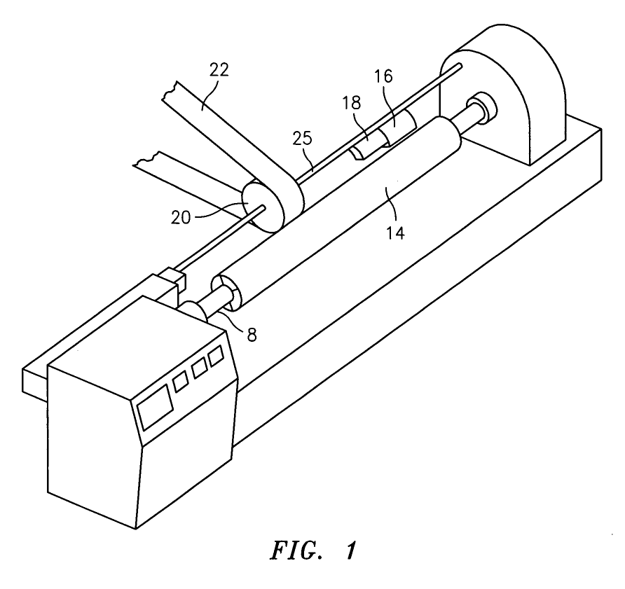

In a first embodiment of the invention, as depicted in FIG. 1, the printing element 14 is supported on a cylindrical printing mandrel 8. The printing element 14 can be in the form of a continuous (seamless) sleeve or a flat, planar plate that is mounted directly on the printing mandrel 8 or alternatively, may be mounted on a carrier sleeve (not shown) and then mounted on the printing mandrel 8. The printing element 14 may be mounted on the printing mandrel 8 using any suitable means, including vacuum, adhesive, and/or mechanical clamps.

The system comprises means 16 for creating a digitally imaged layer on the surface 12 of the at least one photopolymerizable layer of printing element 14, which is preferably at least one ink jet print head 16 (or other imaging means, as discussed above). Mounted adjacent to the at least one ink jet print head 16 is at least one source of actinic radiation 18. The at least one inkjet print head 16 and the at least one source of actinic radiation are mounted on carriage 25 that is capable of traversing the length of the relief image printing element 14.

During operation, the carriage 25 traverses the at least one ink jet print head 16 and the at least one sources of actinic radiation 18 over the length of the imageable surface 12 of the relief image printing element 14 to image and expose the relief image printing element 14. While the carriage 25 traverses the length of the surface 12 of the relief image printing element 14, the relief image printing element 14 is continuously rotated in a first direction so that the entire surface 12 of the relief image printing element 14 is imaged and exposed. Thereafter, the imaged and exposed surface 12 of the relief image printing element 14 is thermally developed to soften and remove uncrosslinked photopolymer.

The thermal developer typically comprises:

a) means for softening or melting non-crosslinked photopolymer on the imaged and exposed surface 12 of the relief image printing element 14;

b) at least one roll 20 that is contactable with the imaged and exposed surface 12 of the relief image printing element 14 and capable of moving over at least a portion of the imaged and exposed surface 12 of the relief image printing element 14 to remove the softened or melted non-crosslinked photopolymer on the imaged and exposed surface 12 of the relief image printing element 14; and

c) means 34 for maintaining contact between the at least one roll 20 and the imaged and exposed surface 12 of the relief image printing element 14.

The thermal developer removes non-crosslinked photopolymer from the imaged and exposed surface 12 of the relief image printing element 14 by rotating the at least one roll 20 over at least a portion of the imaged and exposed surface 12 of the relief image printing element 14. Preferably, the at least one roll 20 rotates in a first direction and the cylindrical relief image printing element 14 rotates in an opposite direction from the at least one roll 20.

The relief image printing element 14 is continuously rotated in the first direction during the imaging, exposing and developing steps so that the entire imaged surface 12 of the relief image printing element 14 can be imaged, exposed and developed. The spiral nature of this process, wherein the printing sleeve rotates as the carriage 25 traverses the length of the relief image printing element 14 ensures even imaging, exposure and development across any size printing element 14.

The at least one roll 20 may be mounted on the same carriage 25 as the ink jet print head and the at least one source of actinic radiation 18, or may be mounted on a separate carriage (not shown). The advantage to this design feature is that movement of the roll across the surface of the printing element allows the system of the invention to accommodate printing elements of various lengths and diameters. In this case, the at least one roll rotates along the length or around the circumference of the printing element and also moves in a direction parallel to the axis of rotation along the width of the printing element.

In one embodiment, the at least one roll 20 is heated and is moved over at least a portion of the imaged and exposed surface 12 of the relief image printing element 14. Non-crosslinked photopolymer on the imaged surface 12 of the relief image printing element 14 can thus be softened or melted and removed by the at least one heatable roll 20.

In the alternative, a heating source 40 may be positioned prior to the roll 20 to soften or melt non-crosslinked polymer on the imaged and exposed surface of the relief image printing element for subsequent removal by the roll 20. The heating source 40 may also be used in conjunction with the heated roll 20 to at least partially soften or melt non-crosslinked polymer on the imaged surface of the relief image printing element. The roll 20 is urged against the surface of the relief image printing element to maintain contact between the at least one roll 20 and the imaged and exposed surface 12 of the relief image printing element 14.

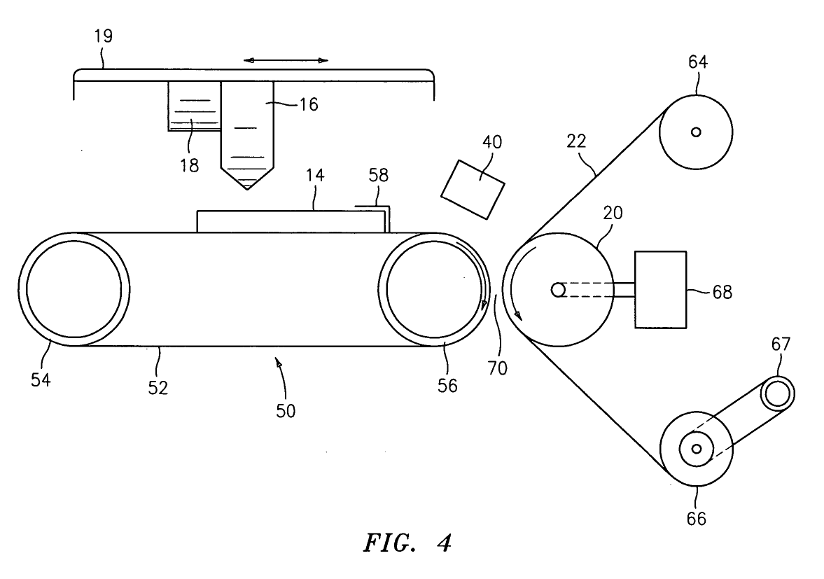

The blotting material 22 is preferably looped under and around at least the portion of the at least one roll 20 that contacts the imaged surface 12 of the relief image printing element 14. The blotting material 22 is continuously supplied to the at least one roll 20 from a remote source (as shown in FIG. 4) of the blotting material 22. The thermal developing system also comprises a rewind device (as shown in FIG. 4) to carry away the blotting material 22 that contains the removed non-crosslinked photopolymer.

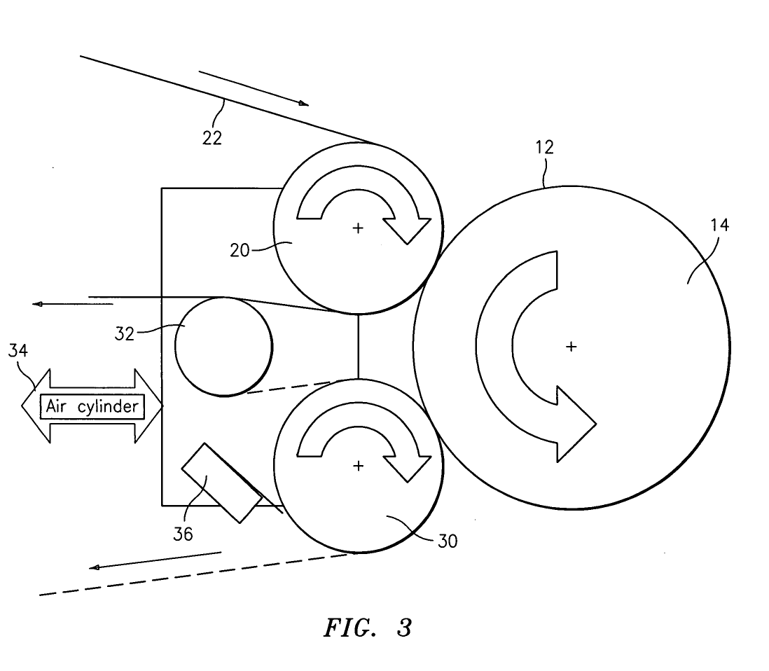

In addition, as seen in FIG. 3, the thermal developer may comprise two rolls 20 and 30 that are opposably positionable adjacent and apart from each other and are each maintainable in contact with the imaged surface 12 of the relief image printing element 14. When the two rolls 20 and 30 are contacted with the imaged surface 12 of the relief image printing element 14, the two rolls 20 and 30 are self-centering against the imaged surface 12 of the relief image printing element 14.

In this embodiment, the blotting material 22 is continuously fed to the two rolls 20 and 30 by looping the blotting material 22 under and around at least the portion of the first roll 20 that is contactable with the imaged surface 12 of the relief image printing element 14, looping the blotting material 22 around one or more track rolls 32 positioned between the two rolls 20 and 30, and then looping the blotting material 22 under and around at least the portion of the second roll 30 that is contactable with the imaged surface 12 of the relief image printing element 14.

In another embodiment, the thermal developer comprises a doctor blade 36 that is positionable adjacent to the at least one roll 20 or 30, which as seen in FIG. 3, may be positioned adjacent to the second roll 30. The doctor blade may be used in place of the blotting material 22. When the at least one roll 20 removes non-crosslinked photopolymer from the imaged surface 12 of the relief image printing element 14, the doctor blade 36 wipes the non-crosslinked photopolymer from the surface of the at least one roll 30.

The means 34 for maintaining contact between the at least one roll 20 and the imaged surface 12 of the relief image printing element 14 typically comprises an air cylinder or a hydraulic cylinder that acts to force the at least one roll 20 against the imaged surface 12 of the relief image printing element 14. Other means for maintaining the contact between the at least one roll 20 and the relief image printing element 14 would also be known to one skilled in the art.

Furthermore, as described in detail in U.S. patent application Ser. No. 10/891,351 to Markhart, the subject matter of which is herein incorporated by reference in its entirety, the thermal developing device may further comprise one or more additional rolls that are positionable in an opposing position on an opposite side of the cylindrical relief image printing element to increase the rate of resin removal as well as the imaging speed.

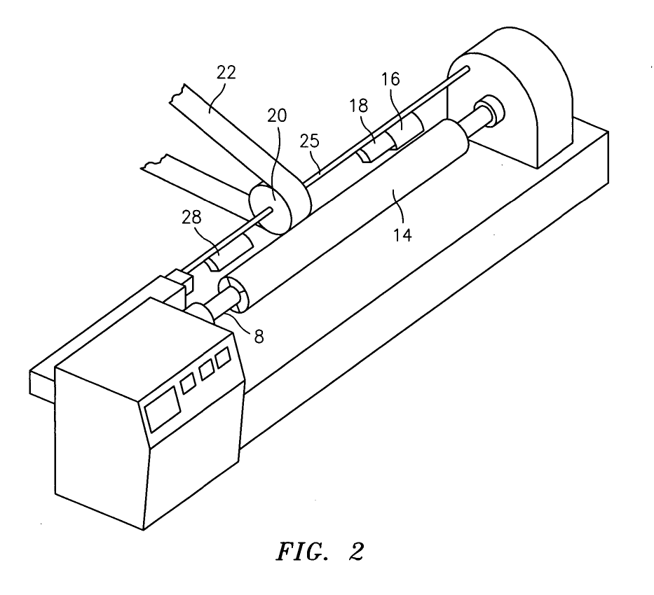

In another embodiment, as depicted in FIG. 2, the thermal development system of the invention further comprises a device 28 for detacking and post-curing the relief image printing element 14 once the relief image printing element 14 has been exposed with the one or more UV lights 18 and thermally developed with the at least one roll 20. The use of the detacking and post-curing device 28 in the system of the invention eliminates the need for handling the printing element, i.e., moving the printing element to a subsequent system, and again provides for a more precise and accurate printing element.

In another preferred embodiment of the invention, as seen in FIG. 4, the printing element may be a substantially planar printing element that is supported on a substantially planar support such as a continuous loop 52 of a conveyor 50.

The conveyor 50 attached to a drive motor (not shown) is used to transport and convey the photosensitive printing element 14 through the combined imaging, exposing, and developing system of the invention. The conveyor 50 is mounted in a fixed position and comprises a continuous loop 52 supported by at least a first roller 54 and a second roller 56. Optionally, one or more additional rollers (not shown) may be used to provide additional support to the conveyor 50 and prevent the continuous loop 52 from sagging from the weight of the photosensitive printing element 14. In a preferred embodiment, the continuous loop 52 comprises wire mesh.

The leading edge of the photosensitive printing element 14 may be held in place against the continuous loop 52 of the conveyor 50 by suitable fastening means 58, such as a clamp and/or vacuum. If desired, a vacuum may be provided to at least one of the first roller 54 and the second roller 56 of the conveyor 50, and used, alone or in combination with fastening means 58, to hold the photosensitive printing element 14 in place on the continuous loop 52 of the conveyor 50.

The at least one inkjet print head 16 (or other imaging means) and the exposure unit 18 are mounted on a carriage 19 mounted above the conveyor 50 for moving the inkjet print head 16 and the exposure unit 18 back and forth over the photosenisitive printing element as the conveyor 50 moves the photosensitive printing element 14 through the system of the invention. In the alternative, the imaging means 16 and the exposure unit 18 may be mounted in a stationary position and the photosensitive printing element is moved past the imaging means 16 and the exposure unit 18 on the continuous loop 52 of the conveyor 50.

Once the photosensitive printing element has been imaged and exposed, the conveyor 50 with photosensitive printing element 14 moves towards the at least one heatable roll 20 so that the photosensitive printing element 14 passes through a gap 70 between the conveyor 50 and the at least one heatable roll 20 as the continuous loop 52 of conveyor 50 rotates over and around the second roller 56. The at least one heatable roll 20 rotates in an opposite direction from the conveyor 50. The at least one heatable roll 20 is capable of being urged towards the photosensitive printing element 14 positioned on the conveyor 50 as the conveyor moves in first direction and the at least one heatable roll 20 moves in an opposite direction. Preferably, the at least one heatable roll 20 is fixably mounted on a pivot (not shown), which allows it to be urged towards the conveyor 50.

In a preferred embodiment, the at least one heatable roll 20 is urged toward the photosensitive printing element 14 on the conveyor 50 using suitable means, such as one or more pneumatic cylinders 68. The pneumatic cylinder(s) 68 positions the at least one heatable roll 20 at a preset distance from the outer surface of the second roller 56 of the conveyor 50 to produce the gap 70 through which the photosensitive printing element 14 passes as it travels on the continuous loop 52 of the conveyor 50 around the second roller 56.

The web of absorbent material 22 is conducted over at least a portion of an outer surface of the at least one heatable roll 20. The web of absorbent material 22 is capable of absorbing (removing) material that is liquefied or softened from the photosensitive printing element 14 when the at least one heatable roll 20 rotates and is heated and the web of absorbent material 22 contacts at least a portion of the photosensitive printing element 14. The at least one heatable roll 20 rotates in a direction opposite to the direction of the conveyor 50 so that the photosensitive printing element 14 and the web of adsorbent material 22 can be contacted with each other and then separated.

The pneumatic cylinder 68 is controlled to adjust the gap 70 depending on the thickness of the photosensitive printing element 14. The pneumatic cylinder(s) 68 causes the at least one layer of photosensitive material 14 and the web of absorbent material 22 to come into contact at the gap 70 between the conveyor 50 and the at least one heatable roll 20 as the conveyor 50 rotates in a first direction and the at least one heatable roll 20 rotates in an opposite direction such that at least a portion of the liquefied or softened photopolymer is absorbed by the web of absorbent material 22.

Heat is provided to the at least one heatable roll 20 by a core heater that is capable of maintaining a skin temperature of the at least one heatable roll 20 that will soften or liquefy at least a portion of the photosensitive material. The temperature to which the at least one heatable roll 20 is heated is chosen based on the composition of the photosensitive material and is based on the melting temperature of the monomers and polymers contained within the photosensitive material. Although the at least one heatable roll 20 preferably comprises an electrical core heater to provide the desired skin temperature, the use of steam, oil, hot air, and a variety of other heating sources may also provide the desired skin temperature.

The web of absorbent material 22 is supplied to at least the portion of the outer surface of the at least one heatable roll 20 from a supply roll 64 of the web of absorbent material 22.

Suitable means for maintaining uniform tension in the web of absorbent material throughout the system may be used, including for example, one or more idler rollers (not shown).

In a preferred embodiment, a take-up roller 66 is provided for winding the web of absorbent material 22 after processing through the plate processor. If present, the take-up roller 66 is independently belt driven by a motor 67, which is preferably a variable speed motor. The take-up roller 66 collects the web of adsorbent material 22 after it has contacted the photosensitive printing element 14 and removed portions of the photosensitive material that were liquefied or softened.

The present invention is also directed to a method of imaging, exposing and developing a printing element to create a relief image thereon, the method comprising the steps of:

a) supporting a printing element comprising at least one photopolymerizable layer on a support layer;

b) creating a digitally-imaged mask layer on the at least one photopolymerizable layer;

c) exposing the at least one photopolymerizable layer to actinic radiation through the digitally-imaged mask layer to crosslink and cure selected portions of the at least one photopolymerizable layer;

d) melting or softening non-crosslinked photopolymer on the imaged and exposed surface; and

e) causing contact between the imaged and exposed surface and at least one roll to remove non-crosslinked photopolymer from the imaged and exposed surface of the relief image printing element.

As discussed above, in one embodiment, non-crosslinked photopolymer on the imaged and exposed surface of the relief image printing element is melted or softened by heating the at least one roll that contacts the imaged and exposed surface of the relief image printing element.

In another embodiment, the non-crosslinked photopolymer on the imaged and exposed surface of the relief image printing element is melted or softened by positioning a heater adjacent to the imaged and exposed surface of the relief image printing element to soften or melt the non-crosslinked photopolymer for subsequent removal by the at least one roll. The heated roll and infrared heater may also be used together to facilitate additional removal of non-crosslinked photopolymer. If used, the at least one heated roll is typically maintained at a temperature that is between the melt temperature of the uncured photopolymer on the low end and the melt temperature of the cured photopolymer on the upper end. This will allow selective removal of the photopolymer thereby creating the image. Preferably the at least one heated roll is maintained at a temperature of about 350° F. to about 450° F. Heat is provided to the heatable roll 20 by a core heater that is capable of maintaining a skin temperature of the heatable roll 20 that will soften or liquefy at least a portion of the photopolymerizable material. The temperature to which the heatable roll 20 is heated is chosen based on the composition of the at least one photopolymerizable layer and is based on the melting temperature of the monomers and polymers contained within the photopolymerizable material.

As discussed above, the method may also include a step of detacking and post-curing the exposed and thermally developed printing element.

While the invention has been particularly shown and described with respect to preferred embodiments thereof, it will be understood by those skilled in the art that changes in form and details may be made therein without departing from the scope and spirit of the invention.

It can thus be seen that the present invention provides for significant advancements over the prior art in accomplishing multiple steps in the same system.

It is also to be understood that the following claims are intended to cover all of the generic and specific features of the invention described herein and all statements of the scope of the invention which as a matter of language might fall therebetween.

1-32. (canceled)

33. A method of imaging, exposing and developing a printing element to create a relief image thereon, the method comprising the steps of:
a) supporting a printing element comprising at least one photopolymerizable layer on a support layer on a supporting means;
b) creating a digitally-imaged mask layer on the at least one photopolymerizable layer;
c) exposing the at least one photopolymerizable layer to actinic radiation through the digitally-imaged mask layer to crosslink and cure selected portions of the at least one photopolymerizable layer;
d) developing the printing element by melting or softening non-crosslinked photopolymer on the imaged and exposed surface; and
causing contact between the imaged and exposed surface and a blotting material to remove non-crosslinked photopolymer from the imaged and exposed surface of the relief image printing element;
wherein the steps of imaging, exposing and developing are performed while the printing element is supported on the supporting means and without handling the printing element between the imaging, exposing and developing steps.

34. The method according to claim 33, wherein the printing element is back exposed prior to the imaging step.

35. The method according to claim 33, further comprising a step of detacking and post-curing the relief image printing element.

36. The method according to claim 33, wherein the printing element is a substantially planar printing element that is wrapped around and supported by a cylindrical printing mandrel or is a continuous cylindrical printing sleeve supported on the cylindrical printing mandrel.

37. The method according to claim 33, wherein the printing element is a substantially planar printing element and the supporting means is a continuous loop of a conveyor.

38. The method according to claim 33, wherein the digitally-imaged mask layer is created on the at least one photopolymerizable layer by a method selected from the group consisting of inkjet printing, laser imaging, and thermal printing.

39. The method according to claim 38, wherein the digitally-imaged mask layer is created by moving at least one inkjet print head that is capable of depositing jetting fluid over the photopolymerizable layer to deposit jetting fluid in a pattern on the at least one photopolymerizable layer.

40. The method according to claim 39, wherein the jetting fluid is deposited on top of an ink receiving layer on top of the layer of photocurable material.

41. The method according to claim 39, wherein the jetting fluid is selected from the group consisting of water-based inks, solvent-based inks, and phase-change inks.

42. The method according to claim 38, wherein the printing element comprises a laser ablatable layer on top of the photopolymerizable layer, and the digitally-imaged mask layer is created by selectively ablating the laser ablatable layer using an IR laser.

43. The method according to claim 38, wherein the printing element comprises a transparent layer on top of the photopolymerizable layer that is capable of becoming opaque under the influence of heat, and the digitally-imaged mask layer is created by selectively heating the transparent layer with a thermal printing head to create the desired image.

44. The method according to claim 38, wherein the imaging means is mounted on a reciprocating carriage, and the reciprocating carriage traverses the length of the printing element.

45. The method according to claim 33, wherein the at least one source of actinic radiation comprise one or more ultraviolet lights.

46. The method according to claim 44, wherein the at least one source of actinic radiation is mounted adjacent to the imaging means, whereby as the photopolymerizable layer is imaged, the at least one source of actinic radiation cures the image substantially as it is formed.

47. The method according to claim 48, wherein an air cylinder or a hydraulic cylinder is used to maintain contact between the blotting material and the imaged surface of the relief image printing element.

48. The method according to claim 33, wherein the blotting material is supported by at least one roll that is contactable with the imaged surface of the relief image printing element.

49. The method according to claim 48, wherein the blotting material is looped under and around at the least the portion of the at least one roll that contactable with the imaged surface of the relief image printing element.

50. The method according to claim 33, wherein the blotting material is selected from the group consisting of screen mesh, woven fabrics, non-woven fabrics, and paper.

51. The method according to claim 50, wherein the blotting material is dark-colored or is substantially the same color as the layer of photopolymerizable material being removed.

52. The method according to claim 48, wherein the non-crosslinked photopolymer on the imaged and exposed surface of the relief image printing element is melted or softened by heating the at least one roll while the blotting material contacts the imaged and exposed surface of the relief image printing element.

53. The method according to claim 33, wherein the non-crosslinked photopolymer on the imaged and exposed surface of the relief image printing element is melted or softened by positioning a heater adjacent to the imaged and exposed surface of the relief image printing element.

54. The method according to claim 52, further comprising a heater positioned adjacent to the imaged and exposed surface of the relief image printing element to provide additional melting or softening of the non-crosslinked photopolymer.

55. The method according to claim 48, wherein the at least one roll traverses the length of the relief image printing element.

56. The method according to claim 55, wherein the at least one roll traverses the length of the relief image printing element multiple times in a spiral or stepwise manner.

57. The method according to claim 55, wherein the at least one roll rotates in a first direction and the cylindrical relief image printing element rotates in an opposite direction from the at least one roll.

58. (canceled)

59. The method according to claim 48, wherein the at least one roll comprises two rolls that are positioned adjacent and apart from each other and are each maintained in contact with the imaged surface of the relief image printing element and wherein the two rolls are self-centering against the imaged and exposed surface of the relief image printing element.

60. The method according to claim 59, wherein the blotting material is continuously fed to the two rolls by wrapping blotting material around at least the portion of the first roll that is in contact with the imaged surface of the relief image printing element, looping the blotting material around one or more track rolls positioned between the two rolls, and then wrapping the blotting material around at least the portion of the second roll that is in contact with the imaged surface of the relief image printing element.
